(19) United States
(12) Patent Application Publication
(10) Pub. No.: US 2026/0296423 A1
(43) Pub. Date: Oct. 1, 2026

(54) METHOD FOR OPERATING A DRIVER ASSISTANCE SYSTEM

(71) Applicant: Volkswagen Aktiengesellschaft, Wolfsburg (DE)

(72) Inventors: Johanna Sandbrink, Wolfsburg (DE); Philipp Terfloth, Wolfsburg (DE)

(21) Appl. No.: 19/629,781

(22) Filed: Mar. 26, 2026

(30) Foreign Application Priority Data
Mar. 28, 2025 (DE) 102025112291.1

(51) Int. Cl. B60W 30/14; B60W 50/08

(52) U.S. Cl. CPC B60W 30/143; B60W 50/085; B60W 2555/60

(57) ABSTRACT

A method is provided for operating a driver assistance system configured for longitudinally guiding a motor vehicle, wherein an actual vehicle speed is controlled to a target vehicle speed while the vehicle is in motion. The system includes a setting unit configured to manually set the target vehicle speed and a speed unit configured to determine a speed specification for a road segment. When a change in the speed specification is detected, the newly determined speed specification is compared with the target vehicle speed. The newly determined speed specification is automatically adopted unless the manually set target vehicle speed is lower than both a previously determined speed specification and the newly determined speed specification. When the target vehicle speed is manually set, a deviation from the speed specification is determined and compared to a threshold value, and the speed specification is adopted when the deviation is within the threshold.

### RELATED APPLICATIONS

The present application claims priority to German Patent App. No. DE 10 2025 112 291.1, to Sandbrink et al., filed Mar. 28, 2025, the contents of which are incorporated by reference in their entirety herein.

### TECHNICAL FIELD

The present disclosure relates to a method for operating a driver assistance system for longitudinally guiding a motor vehicle. The present disclosure further relates to a driver assistance system and to software configured to carry out the method.

### BACKGROUND

Modern motor vehicles are commonly equipped with various driver assistance systems that support a driver in operating the motor vehicle. Such driver assistance systems are configured to detect and evaluate the surroundings of the motor vehicle in order to recognize potentially dangerous situations, in particular collision hazards, at an early stage and to assist the driver in performing driving maneuvers or to avoid such situations.

As used herein, a driver assistance system (advanced driver assistance system, ADAS) is to be understood as a device of a motor vehicle that supports the driver in operating the motor vehicle. Such driver assistance systems may be configured as information systems that provide supporting information to the driver (for example, directional arrows on a display), or as driving systems that automatically influence locomotion of the motor vehicle (for example, steering and/or acceleration).

Driver assistance systems for longitudinally guiding the motor vehicle, such as adaptive cruise control systems (ACC), are configured to control and/or regulate an actual vehicle speed to a target vehicle speed while the vehicle is in motion.

In some examples, cruise control systems detect speed specifications during operation using traffic sign recognition systems, such as camera-based sensors, and/or by using map data. In predictive adaptive cruise control systems (predictive ACC, pACC), control of the distance and speed is enhanced by incorporating anticipatory information relating to the route and/or sign recognition. In contrast to conventional cruise control systems, data relating to the driving route (for example, curves, downhill grades, uphill grades, and speed limits) is also considered in determining the speed specification, such that speed adaptations can be determined in an anticipatory manner and with improved efficiency. For example, such prediction may determine, based on map data, sensor data, and sign recognition, that a new speed specification will apply in a predetermined distance (for example, 300 meters), allowing the driver assistance system to prepare an appropriate speed in advance.

The determined or predicted speed specifications may be displayed to the driver and may optionally be adopted for controlling the vehicle, for example by adapting the target vehicle speed for a longitudinal guidance assistance system. As used herein, a “speed specification” refers to a speed limitation (for example, a speed restriction or speed limit), that is, a specified maximum speed value for the vehicle speed that is not to be exceeded on a particular road segment. Such a specification may be defined by traffic signs, electronic displays, legal regulations, or predictive determinations.

Due to legal requirements or technical regulations relating to driver assistance systems, in some scenarios, if a current target vehicle speed prior to a change corresponds to a target vehicle speed set by the driver, the current target vehicle speed is not automatically adjusted to a newly determined speed specification when the driver-set target vehicle speed is below both a previously determined speed specification and the newly determined speed specification.

This may lead to the following situation when predictive cruise control is activated. If the cruise control system is activated within city limits at speeds below 50 km/h, that is, below a speed specification of 50 km/h, the predictive cruise control system is not permitted to automatically increase the target vehicle speed to 100 km/h when leaving the city limits. However, if the cruise control system is activated within city limits at speeds greater than or equal to 50 km/h, the predictive cruise control system may automatically increase the target vehicle speed to 100 km/h upon exiting the city limits. Accordingly, a deliberate reduction of the target vehicle speed, or activation below the applicable speed specification, may prevent automatic adjustment of the target vehicle speed, such that system behavior differs from previously expected operation.

User interfaces within a motor vehicle, such as driver information displays or input and function elements on a steering wheel, are typically designed to be simple and clear in order to reduce operational complexity and improve intuitive interaction. However, such simplification may result in reduced information being provided to the driver regarding the operating principles of the driver assistance function, which can make it more difficult to understand system logic and proper usage. In particular, insufficient feedback or indications may lead to the driver inadequately learning the operating principles of the driver assistance function or misinterpreting such principles.

### SUMMARY

Some aspects of the present disclosure relate to technologies and techniques for operating a driver assistance system for longitudinally guiding a motor vehicle. In some examples, the likelihood is increased that the driver assistance system is activated within a speed window, or is set such that higher speed specifications can be automatically adopted, thereby improving driver support.

Some aspects of the present disclosure are described in the independent claims. Additional aspects, embodiments, and refinements are set forth in the dependent claims.

Features and advantages described with respect to the method are also applicable to the driver assistance system and/or the software, and vice versa. Where method steps are described, corresponding configurations of the driver assistance system and/or the software may be configured to carry out one or more of these steps.

As used herein, the conjunction “and/or” indicates that the features connected by this term may be implemented jointly or alternatively.

In some examples, a method is provided for operating a driver assistance system configured for longitudinal guidance of a motor vehicle. When the driver assistance system is active, an actual vehicle speed is adjusted to a target vehicle speed while the vehicle is in motion. The driver assistance system may be configured as a cruise control system (ACC) or a predictive cruise control system (pACC), in which a value of the target vehicle speed is dynamically adapted based on a speed specification.

The driver assistance system may include an interface for a driver of the motor vehicle, through which the driver interacts with the driver assistance system. In some examples, the interface is implemented as a human-machine interface (HMI) including one or more input devices and output devices that enable transmission of information between the driver and the driver assistance system.

In some examples, the interface includes a setting unit configured as an input device for manually setting the target vehicle speed. The interface may further include a display unit configured as an output device.

In some examples, a driver assistance system is provided for longitudinally guiding a motor vehicle. During operation, the driver assistance system controls an actual vehicle speed to a target vehicle speed while the vehicle is in motion. The driver assistance system may be implemented as a cruise control system (ACC), and in some examples as a predictive cruise control system (pACC).

The driver assistance system may include a setting unit configured for manually setting a target vehicle speed, and a speed unit configured to determine a speed specification associated with a current and/or future road segment.

The driver assistance system may further include a controller coupled to the setting unit and the speed unit. The controller may also be coupled to a speed sensor configured to detect the actual vehicle speed.

In some examples, the controller is configured, by programming and/or circuitry, to carry out operations including determining a deviation between the manually set target vehicle speed and the speed specification when a speed specification is determined and the target vehicle speed is manually set, comparing the deviation to a stored threshold value, and adopting the determined speed specification as the target vehicle speed when the deviation is less than or equal to the threshold value.

In some examples, the controller includes a microcontroller having a processor and a data memory, wherein functionality for carrying out the method is implemented as operating software stored in the data memory, such that the method is automatically executed when the operating software is run by the microcontroller, optionally in interaction with the driver. In some examples, the controller may alternatively be implemented as a non-programmable electronic component, such as an application-specific integrated circuit (ASIC) or a field programmable gate array (FPGA), in which functionality for carrying out the method is implemented by circuitry.

In some examples, software is provided on a data carrier for carrying out the method described herein. The software includes instructions that, when executed by a computer, in particular by the controller of the driver assistance system, cause the computer to perform the method. The software may be implemented as operating software (firmware), and the data carrier may be, for example, a data memory of the controller.

### BRIEF DESCRIPTION OF THE DRAWINGS

Further advantages, features, and details of the present disclosure are described in greater detail below with reference to the drawings and the accompanying description, in which:

FIG. 1 shows a motor vehicle comprising a driver assistance system for longitudinal guidance, according to some aspects of the present disclosure;

FIG. 2 shows an input unit of the driver assistance system, according to some aspects of the present disclosure;

FIG. 3 shows a display unit of the driver assistance system including a visual indication, according to some aspects of the present disclosure;

FIG. 4 shows a flow chart of a method for operating the driver assistance system, according to some aspects of the present disclosure;

FIG. 5 shows logic associated with the method for adopting a determined speed specification, according to some aspects of the present disclosure; and

FIG. 6 shows logic associated with the method for setting a target vehicle speed, according to some aspects of the present disclosure.

### DETAILED DESCRIPTION

Like elements and variables are denoted by the same reference numerals across all figures.

As used herein, “manually setting the target vehicle speed” refers to establishing the target vehicle speed based on an input initiated by a driver of the motor vehicle. This includes, for example, activation of the driver assistance system, during which a current actual vehicle speed may be adopted as the target vehicle speed.

In some examples, the setting unit includes a button unit configured as an operating element, for example arranged on a steering wheel of the motor vehicle, through which the target vehicle speed can be manually increased or reduced, for example incrementally. The button unit may include a plurality of buttons, such as at least two buttons, including a first button configured to increase the target vehicle speed (plus button) and a second button configured to decrease the target vehicle speed (minus button). In some examples, the button unit may include scroll or slide elements configured to increase and decrease the target vehicle speed. In addition, or as an alternative, the button unit may include a further setting button configured to adopt a current actual vehicle speed as the target vehicle speed for longitudinal guidance of the motor vehicle. In some examples, the setting unit may further include a foot pedal configured as an operating element, such as an accelerator pedal or a brake pedal, through which a target vehicle speed can be set above or below a current speed specification.

The driver assistance system further includes a speed unit configured to determine a speed specification associated with a road segment. The speed unit may be configured to detect a speed specification or a change in a current speed specification. For this purpose, the speed unit may include one or more optical sensors (such as a camera), radar systems, and/or a navigation device configured to detect a speed specification or a change thereof on a current road segment or a route segment. The speed unit may further include a traffic sign recognition system configured to evaluate sensor data. In some examples, the speed unit is configured to predictively determine the speed specification. For example, the speed unit may evaluate map data, topographical information, and/or recognized traffic signs to proactively adapt the vehicle speed to upcoming road features, speed limits, or traffic conditions.

During operation of the driver assistance system, the speed unit determines, at regular intervals or continuously, a speed specification associated with a road segment that is currently being driven and/or that will be driven in the future. For example, the speed unit may detect a speed specification for a currently traveled road segment and/or predict a speed specification for a future road segment.

When the speed specification changes from a previously determined speed specification to a newly determined speed specification, the newly determined speed specification and the previously determined speed specification are compared to a current target vehicle speed when the current target vehicle speed has been manually set using the setting unit.

According to the method, the newly determined speed specification is automatically adopted as the target vehicle speed unless the current target vehicle speed is lower than both the previously determined speed specification and the newly determined speed specification. As used herein, “adopting the speed specification as the target vehicle speed” refers to storing a value corresponding to the newly determined speed specification and using that value as the target vehicle speed, such that a previously set target vehicle speed is replaced.

In some examples, when a speed specification is determined and the target vehicle speed is manually set, a deviation between the manually set target vehicle speed and the speed specification is determined in a first operation. In a subsequent operation, the deviation is compared to a stored threshold value. In a further operation, the determined speed specification is adopted as the target vehicle speed when the deviation is less than or equal to the threshold value.

In some examples, the method implements a control logic for the driver assistance system in which an activation or manual adjustment of the target vehicle speed within a threshold value range defined around the speed specification causes the target vehicle speed to be automatically set to the speed specification.

According to the method, the determined speed specification may function as an attractor when setting the target vehicle speed, wherein an attraction range in which the target vehicle speed is set to the speed specification upon activation or adjustment is defined by the threshold value. In some examples, the threshold value corresponds to a range of approximately 0.5% to 5% relative to the speed specification. This range may apply to accelerating changes, decelerating changes, or both.

In some examples, the target vehicle speed is set to the determined speed specification when a deviation between the set target vehicle speed and the speed specification lies within a tolerance range defined by the threshold value. The deviation may be determined as an absolute deviation or a relative deviation. In the case of a relative deviation, a quotient may be determined based on a difference between the speed specification and the target vehicle speed and the speed specification itself. For example, the target vehicle speed may be set to the determined speed specification when the set target vehicle speed lies within a range of the speed specification±5%, and in some examples within a range of ±0.5%.

In some examples, the driver assistance system is configured such that a likelihood is increased that the longitudinal control system is activated within a speed window, or that the target vehicle speed is manually set such that newly determined higher speed specifications can be automatically adopted, thereby improving driver support.

In some examples, when the deviation exceeds the threshold value, an option is generated for the driver, for example in the form of a visual indication, to set the manually set target vehicle speed to the determined speed specification. In other words, the driver may be prompted to adopt the determined speed specification as the target vehicle speed. This may be particularly advantageous when the target vehicle speed is lower than the determined speed specification, enabling the driver to increase the target vehicle speed such that automatic adoption of future speed specifications and corresponding acceleration remain possible.

In some examples, when the target vehicle speed deviates from the determined speed specification by more than the threshold value, an option to adopt a newly recognized or predicted speed specification is presented to the driver. For example, a visual indication may be displayed when the target vehicle speed lies outside a range enabling automatic adoption and the speed unit has detected or predicted a higher speed specification. The indication may include the newly determined speed specification and an associated operating action via the setting unit for adopting the speed specification as the target vehicle speed.

In some examples, when the deviation exceeds the threshold value, a speed deviation between the currently determined speed specification and the target vehicle speed is determined. This speed deviation may be determined as an absolute value (for example, in km/h or mph) or as a relative deviation (for example, in percent).

In some examples, when a speed specification change occurs such that a newly determined speed specification exceeds a previously determined speed specification, an option or suggestion is generated and output to the driver to set the manually set target vehicle speed to the determined speed specification reduced by the determined speed deviation. In this manner, a current speed offset may be maintained when adopting the new speed specification.

In some examples, presentation of the option or suggestion for adoption, including any associated offset, is dependent on a comparison of speed differences and may be provided only when the deviation lies within a predefined range. For example, presentation may occur only when the deviation exceeds a stored minimum value and/or is below a stored maximum value. The minimum and/or maximum values may depend on a road type, such as a rural road or an expressway, and may be defined in absolute or relative terms. For example, on a rural road, an offset range between approximately 3 km/h and 20 km/h may be considered, while on an expressway an offset range between approximately 5 km/h and 30 km/h may be considered.

In some examples, presentation of the indication or suggestion may be suppressed for certain driving situations, such as low load conditions or high vehicle speeds, when it is assumed that a driver has intentionally selected a lower target vehicle speed.

In some examples, the method is configured to reduce departures from an optimal range by modifying manual adjustment of the target vehicle speed. The optimal range refers to a speed range relative to the determined speed specification in which automatic adjustment to a future speed specification remains possible, for example a range greater than or equal to the currently determined speed specification.

As used herein, modifying manual adjustment refers to differentiating manual setting of the target vehicle speed in a non-optimal range relative to an optimal range. In some examples, a non-linear characteristic curve is stored for the setting unit, such that manual adjustment of the target vehicle speed is modified based on the characteristic curve.

In some examples, when a setting operation is performed via a button unit including plus and minus buttons, or via scroll or slide elements, adjustment of the target vehicle speed may follow the stored characteristic curve rather than a linear relationship, such that adjustment within the optimal range is facilitated. In some examples, an asymptotic characteristic curve is stored for both button operation and accelerator pedal operation.

In some examples, feedback may be provided via an accelerator pedal, for example in the form of haptic feedback. For example, the accelerator pedal may vibrate or generate another haptic signal detectable by the driver. In addition, or as an alternative, a characteristic curve associated with the accelerator pedal may be modified to facilitate adjustment within the optimal range and to make adjustment outside the optimal range more difficult.

In some examples, the driver assistance system includes a display unit configured to display a visual indication. The display unit may be implemented as a driver information display and may form part of the interface or human-machine interface, serving as an output device. The display unit may be configured to present vehicle-related information to the driver and may be arranged within a field of view of the driver. For example, the display unit may be implemented as a digital instrument cluster, a screen, an operating and display device such as a touchscreen, or a head-up display. The display unit may be configured to display information associated with the driver assistance system, such as a current vehicle speed, a current speed specification, and/or a target vehicle speed.

In some examples, a visual indication is displayed on the display unit to indicate to a driver whether a newly determined speed specification is automatically adopted as a new target vehicle speed when the newly determined speed specification exceeds a current target vehicle speed.

In some examples, the visual indication is based on a control logic in which a comparison is performed between a currently set target vehicle speed of a longitudinal control system and a maximum permitted speed for a road segment, such that a determination is made as to whether automatic adjustment of the target vehicle speed is permitted in response to a detected or predicted change in the speed specification.

This arrangement improves transparency and learnability of system behavior for the driver by providing visual feedback indicating whether a detected or predicted increase in the speed specification is adopted by the control system.

In some examples, a speed window within which automatic adoption of the newly determined speed specification as the target vehicle speed is possible is displayed as the visual indication. The visual indication may thus represent a speed range within which driver support by the control system is maximized.

In some examples, the visual indication is configured to dynamically display the speed window in which automatic adoption occurs. The visual indication may be integrated into existing display elements of the display unit. For example, the visual indication may be integrated into a speedometer ring to enable the driver to visually assess whether a higher speed specification will be automatically adopted at a current vehicle speed. In some examples, the speedometer ring may be coupled with an indicator that displays a system activation status, including a current target vehicle speed setting. In addition, or as an alternative, a remaining speed range required to reach an optimal speed window may be displayed.

In some examples, the visual indication may be implemented as a separate display element independent of other display elements of the display unit. For example, the visual indication may be provided as an icon or indicator configured to represent whether a newly determined higher speed specification can be automatically adopted. In some examples, a representation of the target vehicle speed may be modified, for example by varying a color or size, depending on whether the target vehicle speed lies within an optimal range.

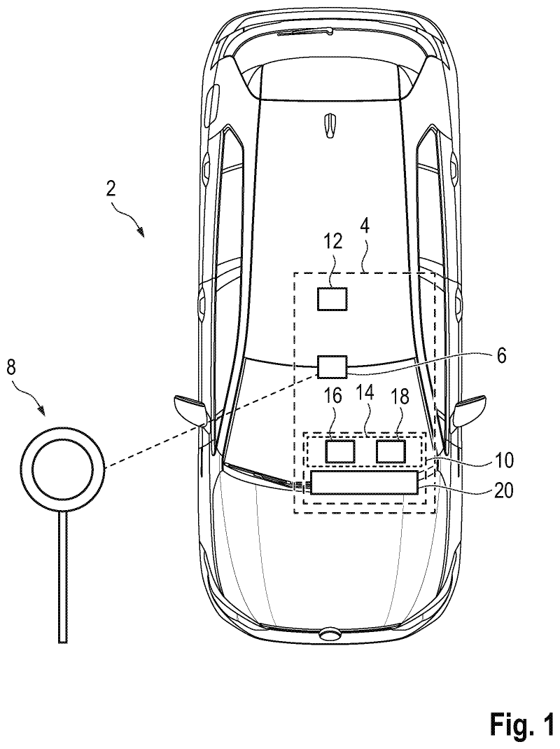

FIG. 1 shows a motor vehicle 2 comprising a driver assistance system 4 configured for longitudinal guidance of the motor vehicle 2, according to some aspects of the present disclosure. The driver assistance system 4 may be implemented as an adaptive cruise control system.

The driver assistance system 4 includes a speed unit 6 configured to determine a speed specification 8 associated with a road segment, an interface 10 configured for interaction with a driver of the motor vehicle 2, and a controller 12.

During operation of the driver assistance system 4, the controller 12 controls an actual vehicle speed I (see FIG. 3) toward a target vehicle speed S (see FIG. 3). The controller 12 is communicatively coupled to the speed unit 6 and the interface 10. The controller 12 includes a memory configured to store the target vehicle speed S. The controller 12 is further coupled to a speed sensor (not shown) configured to detect the actual vehicle speed I. The controller 12 is additionally coupled to a longitudinal guidance unit of the motor vehicle 2 to control the actual vehicle speed I toward the target vehicle speed S.

The speed unit 6 is configured to detect a speed specification 8 or a change in a speed specification 8 on a current road segment or route segment. In FIG. 1, the speed specification 8 is represented, for example, by a traffic sign indicating a speed limit. In some examples, the speed unit 6 includes an optical sensor, such as a camera. In addition, or as an alternative, the speed unit 6 may be configured to predictively determine the speed specification 8 by evaluating map data, topographical information, and/or detected traffic signs to determine a future speed specification.

During operation of the driver assistance system 4, the speed unit 6 determines, at regular intervals or continuously, the speed specification 8 associated with a road segment that is currently being driven and/or that will be driven in the future. For example, the speed unit 6 may detect a speed specification 8 for a currently driven road segment and/or predict a speed specification 8 for a future road segment.

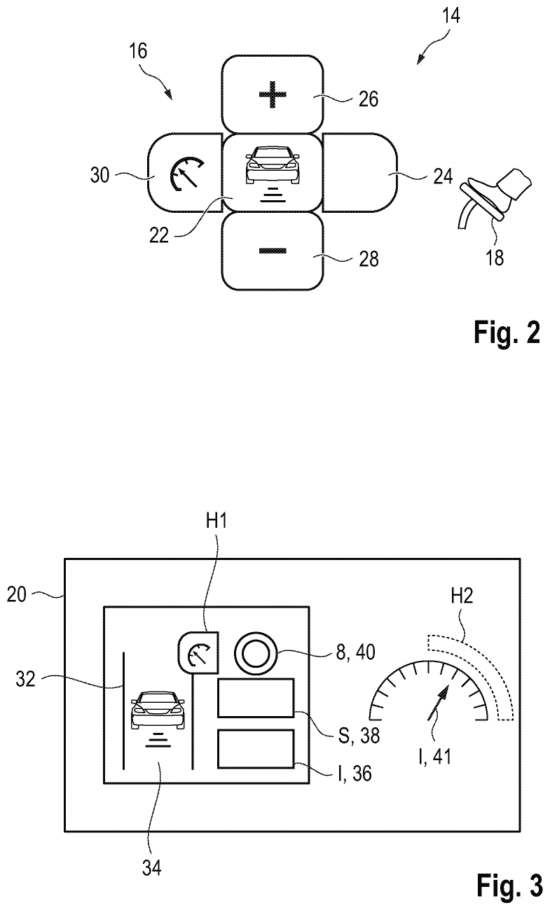

The interface 10 may be implemented as a human-machine interface including a setting unit 14 comprising a button unit 16 and a foot pedal 18, and a display unit 20. The button unit 16 may include a plurality of function buttons arranged, for example, on a steering wheel, as shown in FIG. 2. In some examples, the setting unit 14 may alternatively include scroll and/or slide elements.

The setting unit 14 is configured to manually set or adjust the target vehicle speed S using the button unit 16 and/or the foot pedal 18.

The foot pedal 18 may be implemented as an accelerator pedal and may be configured to influence the actual vehicle speed I. The foot pedal 18 may also be configured to manually set the target vehicle speed S.

The button unit 16 may include a button 22 configured to set a distance or time gap relative to a preceding vehicle, and a button 24 configured to deactivate the driver assistance system 4. The button unit 16 may further include buttons 26, 28, and 30, wherein button 30 is configured to activate the driver assistance system 4. In some examples, the buttons 22-30 are arranged in a cross-shaped configuration, with button 22 positioned centrally, button 24 on a right side, button 28 on a lower side, button 30 on a left side, and button 26 on an upper side.

The button unit 16 is configured to manually set the target vehicle speed S. In the embodiment shown in FIG. 2, the button unit 16 includes three buttons 26, 28, and 30 for manually setting or adjusting the target vehicle speed S. The button 26 is configured to increase a currently set value of the target vehicle speed S, for example incrementally, when actuated. The button 28 is configured to decrease the currently set value of the target vehicle speed S, for example incrementally, when actuated. The button 30 may be configured to adopt a current value of the actual vehicle speed I as the target vehicle speed S when actuated.

In some examples, the target vehicle speed S is set or adjusted via the buttons 26 and 28 in accordance with a stored non-linear characteristic curve, which facilitates setting the target vehicle speed within an optimal range. In some examples, the characteristic curve is dynamically adjusted based on the current target vehicle speed S. For example, an increment used for manual adjustment may be reduced in proximity to a speed specification. For example, the increment may be reduced within a range of approximately ±5% around the speed specification 8 from approximately 5 km/h to approximately 1 km/h.

The display unit 20 may be implemented as a driver information display arranged within a field of view of the driver, for example as a digital instrument cluster. In the embodiment shown, the display unit 20 includes a display window 32 associated with the driver assistance system 4.

The display window 32 includes a display element 34 configured to indicate an activity status of the driver assistance system 4, a display element 36 configured to display the actual vehicle speed I, a display element 38 configured to display the currently set target vehicle speed S, and a display element 40 configured to display a currently determined speed specification 8.

In some examples, the display elements 34 to 40 are displayed when the driver assistance system 4 is activated, for example by actuation of the button 22 or by use of the foot pedal 18. The display of the display elements 34 to 40 may be terminated when the driver assistance system 4 is deactivated, for example by actuation of the button 24.

The display window 32 further includes a display element configured as a visual indication H1.

In some examples, the display unit 20 further includes a display element 41 configured as a speedometer ring for displaying the actual vehicle speed I. A further visual indication H2 may be displayed within a region of the display element 41, for example as needed.

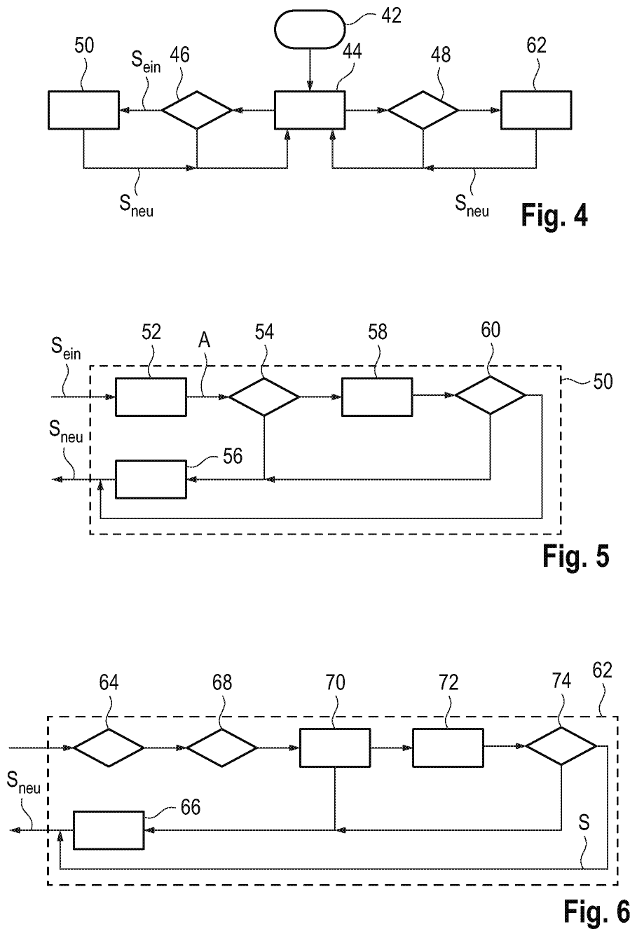

A method for operating the driver assistance system 4 is described with reference to FIGS. 4 to 6. The method may be implemented, for example, by software executed by the controller 12.

The method begins with activation of the driver assistance system 4 in a method step 42. This initiates a control logic 44 configured to control the actual vehicle speed I toward the target vehicle speed S. Upon activation, the current actual vehicle speed I may be adopted as an initial target vehicle speed S, and a speed specification 8 may be determined using the speed unit 6.

Within the control logic 44, a method step 46 monitors whether the target vehicle speed S is manually set or adjusted using the setting unit 14. In addition, a method step 48 determines whether the speed unit 6 detects or predicts a new speed specification 8 or a change in a current speed specification 8. The method steps 46 and 48 may be performed in parallel or sequentially.

If no manual setting or adjustment of the target vehicle speed S is detected in method step 46, the control logic 44 continues without modification. Similarly, if no change in the speed specification 8 is detected in method step 48, the control logic 44 continues without modification.

If a manual setting or adjustment of the target vehicle speed Sₛₑₜ is detected in method step 46, a control logic 50 is initiated to determine and store a new target vehicle speed S_{new}, which is subsequently used as the target vehicle speed S for the control logic 44.

Within the control logic 50 shown in FIG. 5, a deviation A between a currently determined speed specification 8 and the manually set target vehicle speed Sₛₑₜ is determined in a method step 52. In some examples, the deviation A is determined as a relative deviation based on a quotient of a difference between the speed specification 8 and the target vehicle speed Sₛₑₜ and the speed specification 8.

In a subsequent method step 54, the deviation A is compared with a stored threshold value.

If the deviation A is less than or equal to the threshold value, the currently determined speed specification 8 is set as the new target vehicle speed S_{new} in a method step 56, such that the manually set target vehicle speed Sₛₑₜ is replaced by the determined speed specification 8.

The method steps 52, 54, and 56 define a control logic in which a manual adjustment of the target vehicle speed within a threshold range around the speed specification 8 results in automatic adoption of the speed specification 8 as the target vehicle speed.

If the deviation A exceeds the threshold value, an option is generated for the driver, for example via the visual indication H1, and displayed by the display unit 20 in a method step 58. In a subsequent method step 60, it is monitored whether an input is received via the setting unit 14 following presentation of the visual indication H1. For example, if the driver actuates the button 30 while the visual indication H1 is displayed, the determined speed specification 8 is adopted as the new target vehicle speed S_{new}. Otherwise, the manually set target vehicle speed Sₛₑₜ is retained as the target vehicle speed S_{new}.

Accordingly, the method steps 58 and 60 provide an option for the driver to adopt the determined speed specification 8 when the manually set target vehicle speed Sₛₑₜ deviates from the determined speed specification 8 by more than the threshold value.

If a change in the determined speed specification 8 is detected in method step 48, a control logic 62 for adopting the determined speed specification 8 is initiated to determine a new target vehicle speed S_{new}, which is subsequently stored and used as the target vehicle speed S for the control logic 44.

Within the control logic 62 shown in FIG. 6, a method step 64 determines whether the currently stored target vehicle speed S was manually set by the driver or automatically set.

If the current target vehicle speed S was not set based on a manual input by the driver, the newly determined speed specification 8 is set as the new target vehicle speed S_{new} in a method step 66. In other words, the target vehicle speed S is automatically overwritten with the value of the newly determined speed specification 8. The determined speed specification 8 is thus adopted as the new target vehicle speed S_{new} for the control logic 44.

If the current target vehicle speed S was manually set using the setting unit 14, the current target vehicle speed S is compared to a previously determined speed specification 8 and a newly determined speed specification 8 in a method step 68. In other words, when the speed specification changes, the speed specifications 8 determined by the speed unit 6 are compared to the currently set target vehicle speed S when this speed was manually specified by the driver.

Based on a result of the comparison, a visual indication H2 is displayed in a method step 70 to indicate to the driver whether the newly determined speed specification 8 is automatically adopted as the new target vehicle speed S_{new}.

The newly determined speed specification 8 is automatically adopted as the new target vehicle speed S_{new} in method step 66 unless the current target vehicle speed S is lower than both the previously determined speed specification 8 and the newly determined speed specification 8. The visual indication H2 is displayed, for example, when the target vehicle speed S is not within a speed window for automatic adoption and the speed unit 6 has detected or predictively determined a higher speed specification 8.

A functional logic of the control logic 62 is implemented by method steps 64 and 68, in which a comparison between the currently set target vehicle speed S and a maximum permitted speed for a road segment is used to determine whether automatic adjustment of the target vehicle speed S is permitted in response to a detected or predicted change in the speed specification 8. The visual indication H2 provides feedback to the driver as to whether a predicted or detected increase in the speed specification 8 is automatically adopted by the control system.

In the embodiment shown in FIG. 3, a speed window is displayed, for example above the speedometer ring 41, as the visual indication H2. The speed window indicates a range in which automatic adoption of the newly determined speed specification 8 as the new target vehicle speed S_{new} is possible.

If it is determined in method step 68 that conditions for automatic adoption of the newly determined speed specification 8 are not satisfied, such that the manually set target vehicle speed S is lower than both the previously determined and newly determined speed specifications 8, an option is generated for the driver in a method step 72, for example in the form of the visual indication H1, and displayed by the display unit 20.

In a subsequent method step 74, it is monitored whether an input is received via the setting unit 14 following presentation of the visual indication H1. For example, if the driver actuates the button 30 while the visual indication H1 is displayed, the determined speed specification 8 is adopted as the new target vehicle speed S_{new}. If no such input is received, the previously set target vehicle speed S is retained as the target vehicle speed S_{new} for the control logic 44.

The method thus integrates mechanisms via the control logic 50 that increase a likelihood that the target vehicle speed S is set or adjusted such that the control logic 62 can automatically adopt a newly determined higher speed specification 8, thereby improving driver support. The visual indication H2 further provides feedback indicating whether such automatic adoption is occurring or whether additional driver input is required to adjust the target vehicle speed S in response to a change in the speed specification 8.

The control logics 50 and 62 may be implemented in a nested manner. In an alternative embodiment of the control logic 50, it may be provided that, when the deviation A exceeds the threshold value, a visual indication suggests that the driver adopt a newly determined higher speed specification 8 reduced by the deviation A when the target vehicle speed S is lower than the previously determined speed specification 8.

In some examples, presentation of the indication or suggestion may be suppressed for certain driving situations, such as low load conditions or high vehicle speeds, when it is assumed that the driver has intentionally selected a lower target vehicle speed S.

The present disclosure is not limited to the embodiments described herein. Rather, additional variations may be derived by a person having ordinary skill in the art within the scope of the claims. Individual features described in connection with different embodiments may also be combined with one another in various ways within the scope of the claims.

### LIST OF REFERENCE NUMERALS

2 motor vehicle
4 driver assistance system
6 speed unit
8 speed specification
10 interface
12 controller
14 setting unit
16 button unit
18 foot pedal
20 display unit
22 . . . 30 button
32 display window
34 . . . 41 display element
42 method step
44 control logic
46, 48 method step
50 control logic
52 . . . 60 method step
62 control logic
64 . . . 70 method step
72 method step
I actual vehicle speed
S target vehicle speed
Sₛₑₜ set target vehicle speed
S_{new} new target vehicle speed
H1, H2 indication
A deviation

1. A method for operating a driver assistance system for longitudinally guiding a motor vehicle, comprising:
controlling an actual vehicle speed of the motor vehicle toward a target vehicle speed while the motor vehicle is in motion;
determining, via a speed unit, a speed specification associated with at least one of a road segment or a driving environment;
detecting a change from a previously determined speed specification to a newly determined speed specification;
in response to determining that the target vehicle speed was manually set via a setting unit, comparing the previously determined speed specification and the newly determined speed specification with the target vehicle speed; and
automatically adopting the newly determined speed specification by setting the target vehicle speed to the newly determined speed specification unless the target vehicle speed is less than or equal to both the previously determined speed specification and the newly determined speed specification.

2. The method of claim 1, further comprising:
in response to determining that the target vehicle speed is manually set,
determining a deviation between the manually set target vehicle speed and the speed specification;
comparing the deviation to a stored threshold value; and
adopting the speed specification as the target vehicle speed when the deviation is less than or equal to the threshold value.

3. The method of claim 2, further comprising generating, via a display unit, a visual indication providing an option for a driver to set the manually set target vehicle speed to the speed specification when the deviation exceeds the threshold value.

4. The method of claim 2, wherein the deviation comprises a relative deviation determined based on a ratio between a difference of the speed specification and the target vehicle speed and the speed specification.

5. The method of claim 1, further comprising modifying a rate of change of the target vehicle speed in response to an input at the setting unit according to a non-linear characteristic curve.

6. The method of claim 1, further comprising displaying, via a display unit, a visual indication indicating whether the newly determined speed specification is automatically adopted as the target vehicle speed.

7. The method of claim 6, wherein the visual indication comprises a speed window indicating a range in which automatic adoption of the newly determined speed specification is permitted.

8. A driver assistance system for longitudinally guiding a motor vehicle, comprising:
a setting unit configured to manually set a target vehicle speed;
a speed unit configured to determine a speed specification associated with at least one of a road segment or a driving environment; and
a controller coupled to the setting unit and the speed unit, wherein the controller is configured to:
control an actual vehicle speed toward the target vehicle speed;
detect a change from a previously determined speed specification to a newly determined speed specification;
in response to determining that the target vehicle speed was manually set, compare the previously determined speed specification and the newly determined speed specification with the target vehicle speed; and
automatically adopt the newly determined speed specification by setting the target vehicle speed to the newly determined speed specification unless the target vehicle speed is less than or equal to both the previously determined speed specification and the newly determined speed specification.

9. The driver assistance system of claim 8, wherein the controller is further configured to:
determine a deviation between the manually set target vehicle speed and the speed specification;
compare the deviation to a stored threshold value; and
adopt the speed specification as the target vehicle speed when the deviation is less than or equal to the threshold value.

10. The driver assistance system of claim 9, wherein the controller is further configured to generate, via a display unit, a visual indication providing an option for a driver to adopt the speed specification when the deviation exceeds the threshold value.

11. The driver assistance system of claim 8, wherein the setting unit comprises a button unit.

12. The driver assistance system of claim 8, further comprising a display unit configured to display a visual indication indicating whether the newly determined speed specification is automatically adopted.

13. The driver assistance system of claim 12, wherein the visual indication comprises a speed window indicating a range in which automatic adoption is permitted.

14. The driver assistance system of claim 8, wherein the setting unit is configured to modify a rate of change of the target vehicle speed according to a non-linear characteristic curve.

15. A non-transitory computer-readable medium storing instructions that, when executed by one or more processors of a driver assistance system, cause the driver assistance system to:
control an actual vehicle speed toward a target vehicle speed;
determine a speed specification associated with at least one of a road segment or a driving environment;
detect a change from a previously determined speed specification to a newly determined speed specification;
in response to determining that the target vehicle speed was manually set, compare the previously determined speed specification and the newly determined speed specification with the target vehicle speed; and
automatically adopt the newly determined speed specification by setting the target vehicle speed to the newly determined speed specification unless the target vehicle speed is less than or equal to both the previously determined speed specification and the newly determined speed specification.

16. The non-transitory computer-readable medium of claim 15, wherein the instructions further cause the system to:
determine a deviation between the manually set target vehicle speed and the speed specification;
compare the deviation to a threshold value; and
adopt the speed specification when the deviation is less than or equal to the threshold value.

17. The non-transitory computer-readable medium of claim 16, wherein the instructions further cause the system to generate, via a display unit, a visual indication providing an option to adopt the speed specification when the deviation exceeds the threshold value.

18. The non-transitory computer-readable medium of claim 15, wherein the instructions further cause the system to display a visual indication indicating whether the newly determined speed specification is automatically adopted.

19. The non-transitory computer-readable medium of claim 18, wherein the visual indication comprises a speed window.

20. The non-transitory computer-readable medium of claim 15, wherein the instructions further cause the system to modify a rate of change of the target vehicle speed according to a non-linear characteristic curve.
